(19) United States
(12) Patent Application Publication
(10) Pub. No.: US 2026/0278070 A1
(43) Pub. Date: Sep. 17, 2026

(54) RESOURCE CALLING METHOD AND APPARATUS

(71) Applicant: CLOUD INTELLIGENCE ASSETS HOLDING (SINGAPORE) PRIVATE LIMITED, Singapore (SG)

(72) Inventor: Yinde ZHANG, Hangzhou (CN)

(21) Appl. No.: 19/469,626

(22) PCT Filed: Mar. 6, 2024
(86) PCT No.: PCT/CN2024/080355

§ 371 Date: Sep. 26, 2025

(30) Foreign Application Priority Data
Mar. 28, 2023 (CN) 202310319483.0

(51) Int. Cl. G06F 21/53; G06F 9/50

(52) U.S. Cl. CPC G06F 21/53; G06F 9/5055; G06F 2221/034

(57) ABSTRACT

A resource invocation method and electronic device are provided. The method comprises: in response to a resource invocation request initiated by a first user for a target resource, determining a first user sandbox corresponding to the first user, wherein different users respectively correspond to different user sandboxes, and any user sandbox records address information of an callable resource for a corresponding user; and according to resource description information of the target resource, querying target address information of the target resource from address information of a first callable resource recorded in the first user sandbox, and performing resource invocation according to the target address information.

This disclosure claims priority to Chinese Patent Application No. 202310319483.0 entitled “RESOURCE CALLING METHOD AND APPARATUS” filed with the China National Intellectual Property Administration on Mar. 28, 2023, which is incorporated herein by reference in its entirety.

### TECHNICAL FIELD

One or more embodiments of this specification relate to the field of computers, and in particular, to a resource invocation method and apparatus.

### BACKGROUND

Generally, a computer such as a local physical machine or a Virtual Machine (VM) may implement multi-user login, that is, a plurality of users may concurrently log in to one computer, and separately operate the computer to implement corresponding functions.

In a related technology, a plurality of users logging in to the same computer may usually separately access all resources of the computer, which may cause a potential data security risk. Using a virtual machine as an example, in a case that a plurality of users concurrently log in to the same virtual machine, personal data generated by each user usually belongs to the virtual machine. In addition to accessing personal data of the user, any user may further access personal data of another user. In other words, personal data of the plurality of users is visible to each other. Therefore, data isolation cannot be implemented, and data security is relatively low.

### SUMMARY

In view of this, one or more embodiments of this specification provide resource invocation.

To achieve the above objective, one or more embodiments of this specification provide the following technical solution.

According to a first aspect of one or more embodiments of this specification, a resource invocation method is provided, including: determining, in response to a resource invocation request initiated by a first user for a target resource, a first user sandbox corresponding to the first user, where different users respectively correspond to different user sandboxes, and any one of the user sandboxes records address information of an invokable resource of a corresponding user; and querying, according to resource description information of the target resource, target address information of the target resource in the address information of a first invokable resource recorded in the first user sandbox, and performing resource invocation according to the target address information.

According to a second aspect of one or more embodiments of this specification, a resource invocation apparatus is provided, including: a user sandbox determining unit, configured to determine, in response to a resource invocation request initiated by a first user for a target resource, a first user sandbox corresponding to the first user, where different users respectively correspond to different user sandboxes, and any one of the user sandboxes records address information of an invokable resource of a corresponding user; and a target resource invocation unit, configured to query, according to resource description information of the target resource, target address information of the target resource in the address information of a first invokable resource recorded in the first user sandbox, and perform resource invocation according to the target address information.

According to a third aspect of one or more embodiments of this specification, an electronic device is provided, including: a processor; and a memory configured to store instructions executable by the processor, where the processor implements the method according to the first aspect by running the executable instructions.

According to a fourth aspect of one or more embodiments of this disclosure, a computer-readable storage medium is provided, having a computer instruction stored therein, where the instruction implements steps of the method according to any item in the first aspect when executed by a processor.

### BRIEF DESCRIPTION OF THE DRAWINGS

In accompanying drawings, unless otherwise specified, the same reference signs throughout the plurality of accompanying drawings represent the same or similar parts or elements. These accompanying drawings may not necessarily be drawn to scale. It is to be understood that these accompanying drawings only describe some implementations disclosed in this disclosure, and are not to be construed as limiting the scope of this disclosure.

FIG. 1 is a schematic diagram of an architecture of a cloud desktop system according to an exemplary embodiment.

FIG. 2 is a schematic diagram of a resource invocation method according to an exemplary embodiment.

FIG. 3 is a schematic diagram of an internal structure of a computer according to an exemplary embodiment.

FIG. 4 is a schematic structural diagram of a device according to an exemplary embodiment.

FIG. 5 is a block diagram of a resource invocation apparatus according to an exemplary embodiment.

### DETAILED DESCRIPTION

Exemplary embodiments are described in detail herein, and examples of the exemplary embodiments are shown in accompanying drawings. When the following description involves the accompanying drawings, unless otherwise indicated, the same numerals in different accompanying drawings represent the same or similar elements. The implementations described in the following exemplary embodiments are not all the implementations consistent with one or more embodiments of this specification, On the contrary, the implementations only examples of apparatuses and methods that are described in the appended claims in detail and that are consistent with some aspects of one or more embodiments of this specification.

It is to be noted that: steps of a corresponding method are not necessarily performed according to a sequence shown and described in this specification in other embodiments. In some other embodiments, the methods may include more or fewer steps than those described in this specification. In addition, a single step described in this specification may be decomposed into a plurality of steps for describing in other embodiments. The plurality of steps described in this specification may alternatively be combined into a single step for describing in other embodiments.

As described above, a computer may usually implement multi-user login, that is, a plurality of users may concurrently log in to one computer, and separately operate the computer to implement corresponding functions.

In a related technology, a plurality of users logging in to the same computer may usually separately access all resources of the computer, which may cause a potential data security risk. Using a virtual machine as an example, in a case that a plurality of users concurrently log in to the same virtual machine, personal data generated by each user usually belongs to the virtual machine. For any user, in addition to accessing personal data of the user, the user may further access personal data of another user. In other words, personal data of the plurality of users is visible to each other. Therefore, data isolation cannot be implemented, and data security is relatively low.

For the foregoing problem in the related technology, this specification provides a resource invocation method. By setting a corresponding user sandbox for each user, and isolating an invokable resource of each user in advance, an operating system may query target address information of a target resource that the user requests to invoke in address information recorded in a first user sandbox, so that the user is prevented from accessing an invokable resource of another user, and isolation between personal resources of different users is implemented. The method is described in detail with reference to accompanying drawings.

The resource invocation method in this embodiment of this specification may be applied to a computer, and specifically, applied to an operating system of the computer. The computer may be a local computer or a virtual machine. Using the virtual machine as an example, any virtual machine may independently run in a terminal device, or may run together with other virtual machines in a server. For example, a plurality of virtual machines may concurrently run in any server, each virtual machine is controlled by a corresponding operating system, and software and hardware resources of the server may be properly allocated to each virtual machine for use.

A plurality of users may log in to the computer at any moment. In other words, the plurality of users may log in to the computer at the same moment, to serve as users of the computer. In some implementations, a user account that any user logs in to may be an account that is registered in advance in an operating system of the computer, or may be an account that is registered in advance in another platform associated with the operating system, or the like. Details are not described again. After logging in to the computer, these users may be managed by the operating system of the computer.

For each user that has logged in, the operating system of the computer may create corresponding user sandboxes for these users respectively. For example, the operating system may create a corresponding user sandbox for any user after the user logs in, determine address information of an invokable resource of the user, and record the address information in the user sandbox.

In addition, for any user, an application instructed by the user may alternatively run in the user sandbox of the user, to provide a function corresponding to the user for the user. A specific function that can be implemented by the application running in the user sandbox is not limited in the present disclosure. For example, the user may include an office application, a shopping application, a payment application, an instant messaging application, and/or a music application. Details are not described again.

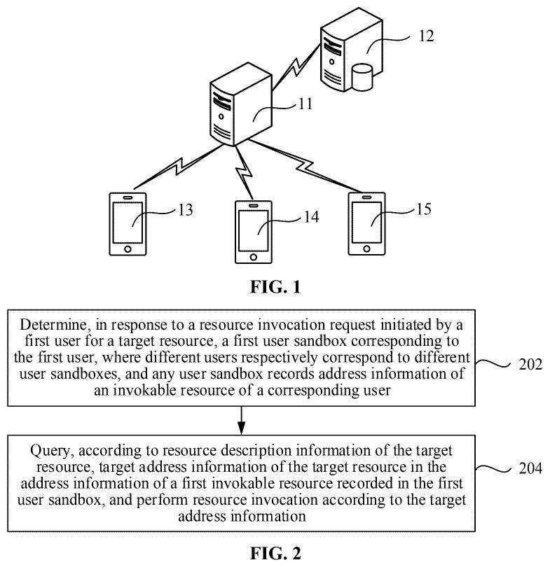

FIG. 1 is a schematic diagram of an architecture of a cloud desktop system according to an exemplary embodiment. The system may include a server 11, a storage device 12, and several electronic devices such as a mobile phone 13, a mobile phone 14, and a mobile phone 15. At least one virtual machine (not shown in the figure) may be deployed in the application server 11. Any virtual machine may run an application locally to implement the virtual machine as an application server, and provide a corresponding application service for an application client.

A cloud desktop is alternatively referred to as desktop virtualization, a cloud computer, and the like, and a computing mode of the cloud desktop may replace a conventional local computer. A user does not need to purchase a computer host, and components such as a Central Processing Unit (CPU), a memory, and a hard disk required for running of the host may be implemented and provided by a resource of a cloud desktop server by using a virtualization technology. The user may use any form of terminal device as a cloud desktop client, and the cloud desktop client is connected to the cloud desktop server through a network. The cloud desktop client and the cloud desktop server cooperate to form a complete computer in a cloud desktop scenario. In a case that a cloud desktop instance is deployed in any virtual machine, based on an application running in the instance, the virtual machine may provide a cloud desktop service for electronic devices such as mobile phones 13 to 15. In this scenario, any virtual machine is implemented as a cloud desktop server, and the mobile phone used by the user is equivalent to a cloud desktop client. It may be understood that the electronic device as an application client may include hardware such as a control module, a communications module, a display, a keyboard, and a mouse, so that a user can exchange information with an application server by using the foregoing hardware.

For any application running in any virtual machine, data (a program, code, or the like) required for running of the application or data (intermediate data, a data processing result, a running record, or the like) generated in a running process may be stored locally in the virtual machine, or may alternatively be stored in the storage device 12. The virtual machine may locally mount data stored in the storage device 12 as a Virtual Hard Disk (VHD) by using a VHD technology, so that remote read and write operations are performed on the data of the VHD during running of the application. Therefore, the application does not need to be locally installed on the virtual machine, application maintenance operations on the virtual machine are simplified, and local storage space of the virtual machine is saved.

In addition, any one of the mobile phones 13 to 15 may run a client program, so that the mobile phone is implemented as a cloud desktop client in a cloud desktop system. The client may essentially be an application, and the application program may be pre-installed on the mobile phone, so that the client may be started and run on a terminal device. Certainly, when an online “client” such as a HyperText Markup Language 5 (HTML5) technology is used, the client can be obtained and run without installing a corresponding application on the mobile phone. Correspondingly, the cloud desktop instance running in the server 11 may be considered as a server program, and any virtual machine runs the program to implement the virtual machine as a server in a cloud desktop system by running the program. Details are not described again.

Any one of the foregoing mobile phones may correspond to a corresponding user. For example, any user may use a user account of the user to log in to a client running in the mobile phone 13, and after logging in, the user may be considered as a user corresponding to the mobile phone 13. The mobile phone 13 may interact with the server 11 during logging in, so that the user can log in to any virtual machine in the server 11. In addition, the mobile phones 13 to 15 are only one type of electronic devices that can be used by the user. The user may further use, for example, the following types of electronic devices: tablet devices, notebook computers, Personal Digital Assistants (PDAs), wearable devices (such as smart glasses and smart watches), Virtual Reality (VR) devices, Augmented Reality (AR) devices, and the like. By running a client program of a cloud desktop on these devices, these devices may be implemented as cloud desktop clients. Certainly, to implement any one of the foregoing electronic devices as the cloud desktop client, the client program may need to be installed in the device or a client program in an online form may be accessed. Actually, a user may further use a cloud desktop dedicated device. For example, the device may be pre-installed with a cloud desktop client. The user only needs to connect a corresponding input/output device to the device to access an application running in a corresponding cloud desktop server by using the cloud desktop client and by implementing corresponding operations, to obtain a cloud desktop service provided by the device.

In addition, the server 11 may be a physical server including an independent host, or may be a virtual server, a cloud server, or the like carried by a host cluster. The storage device 12 may be in any form, for example, may be a structured or non-structured database, or may be a Network Attached Storage (NAS) device. This is not limited in one or more embodiments of this specification.

FIG. 2 is a flowchart of a resource invocation method according to an exemplary embodiment. As shown in FIG. 2, the method is applied to a computer, may be specifically applied to an operating system of the computer, and may include the following steps 202 to 204.

Step 202: Determine, in response to a resource invocation request initiated by a first user for a target resource, a first user sandbox corresponding to the first user. Different users respectively correspond to different user sandboxes, and any one of the user sandboxes records address information of an invokable resource of a corresponding user.

An operating system of the computer described in this specification may be Windows, or may be iOS, Linux, Unix, or the like. Windows is used as an example for description below. A plurality of users may concurrently log in to the computer described in this specification. For the plurality of users, the operating system of the computer may create a corresponding user sandbox for each user. The plurality of users respectively correspond to different user sandboxes. In other words, the plurality of users that have logged in are in a one-to-one mapping relationship with the plurality of user sandboxes created by the operating system. The user sandbox corresponding to any user described in this specification is a program, a rule, or an environment configured for performing permission isolation/management on related data or a resource of the user, and may be configured for recording address information of an invokable resource of the user (that is, a software/hardware resource that the user may invoke). For example, resource description information of these resources and address information of the resources in the computer may be correspondingly recorded, so that the operating system may query address information of any resource according to the resource description information of the resource and invoke the resource.

In addition, the invokable resource of any user (that is, the resource that the user may invoke) may include a system resource provided by the operating system, for example, a hardware resource such as a memory and a CPU, and/or a software resource such as a Software Development Kit (SDK) and file management, and may further include a non-system resource, such as personal data of the user, a low-level library, and a third-party toolkit. The address information of any resource is configured for indicating an access address of the resource, and the resource may be accessed (that is, invoked) by using the address. The address information may be an index corresponding to a data storage address, or may be an invocation interface, a parameter, or the like of a software and hardware resource. A specific form of the address information is not limited in this specification. For example, for an SDK provided by an operating system, address information of the SDK may be a path specified by the operating system for the SDK (the SDK may be invoked through the path). In this manner, the operating system may record address information of invokable resources of different users in different user sandboxes respectively, which is equivalent to respectively maintaining the invokable resources of the different users in different user sandboxes, to isolate personal resources of the different users, and to facilitate subsequent targeted access to the personal resources by various users.

The first user described in this specification may be any user of the plurality of users that log in to the computer, and the operating system of the computer may create a corresponding first user sandbox for the first user when the first user logs in to the computer. After logging in, the first user may process a transaction in the first user sandbox, for example, querying data, editing a file, or running an application. In a process of processing the foregoing transaction, an operating system of a virtual machine needs to be controlled to invoke the invokable resource of the user. In this specification, a process in which the first user requests the operating system to invoke a target resource is described. The target resource may be at least one resource in the invokable resources of the first user.

When needing to invoke the target resource, the first user may initiate a resource invocation request for the resource to the operating system, to trigger the operating system to invoke the resource in response to the request. In an embodiment, the resource invocation method may be applied to a virtual machine in which a cloud desktop instance is deployed. In this case, the first user sandbox may be created and maintained by an operating system of the virtual machine, and the resource invocation request may be initiated to the operating system by using the cloud desktop instance. In this scenario, the virtual machine is equivalent to a cloud desktop server, and a terminal device (which may include a communication module, a display, a keyboard, a mouse, and the like) used by a user may form a cloud desktop client.

A first application may run in the cloud desktop instance, and the application may be released to a cloud application platform in advance. In this case, the virtual machine may provide an application browsing page of the cloud application platform for the cloud desktop client. The page may include display of the first application, for example, a startup control, introduction content, detailed information, an operation guide, or a user rating of the first application. In view of this, the first user may perform a trigger operation for the foregoing display of the first application, and the cloud desktop client may initiate a startup instruction for the first application in response to the trigger operation, to trigger the virtual machine to start the first application. In this manner, the first application may be provided for the first user in a form of a cloud application without actually installing the first application in the virtual machine, which not only helps simplify deployment and maintenance work of the first user on the first application, but also helps save local storage space of the computer, and improves application operation efficiency of the computer. It may be understood that a first application sandbox alternatively belongs to the cloud desktop instance, and the resource invocation request may be initiated to the operating system by the first application in a process in which the first user uses the first application (in this case, the request may still be considered as being initiated by the first user).

In an embodiment, because the computer creates a corresponding user sandbox for each user, to accurately distinguish the user sandboxes respectively corresponding to various users and avoid confusion during use, the operating system may maintain a plurality of mapping relationships. Correspondingly, in response to the resource invocation request, the operating system may determine the first user sandbox corresponding to the first user in a plurality of manners based on the mapping relationship.

For example, the operating system may maintain a first-class user mapping relationship between a user identifier of a user and a sandbox identifier of a user sandbox. Based on this, the operating system may determine, according to the mapping relationship, the sandbox identifier corresponding to the user identifier of the first user, and determine the user sandbox represented by the sandbox identifier as the first user sandbox. In this manner, the operating system may accurately determine the first user sandbox based on the user identifier of the first user. Or, in some scenarios, different users may be respectively connected to the virtual machine through different sessions, that is, the virtual machine is in a multi-session persistence state. The plurality of users are in a one-to-one mapping relationship with a plurality of sessions, any user may be considered as belonging to one session, and each session has a corresponding session identifier. In this case, the operating system may maintain a second-class user mapping relationship between the session identifier of the session to which the user belongs and the sandbox identifier of the user sandbox. Based on this, the operating system may determine, according to the mapping relationship, the sandbox identifier corresponding to the first session identifier of the session to which the first user belongs, and determine the user sandbox represented by the sandbox identifier as the first user sandbox. In this manner, the operating system may accurately determine the first user sandbox based on the session identifier of the session to which the first user belongs.

It may be understood that, the determined first user sandbox records the address information of the invokable resource of the first user, and the target resource is at least one invokable resource. Therefore, target address information of the target resource is naturally recorded in the invokable resource. Therefore, in some implementations, the operating system may query the target address information of the target resource in the address information of the first invokable resource recorded by the first user sandbox.

Step 204: Query, according to resource description information of the target resource, target address information of the target resource in the address information of a first invokable resource recorded in the first user sandbox, and perform resource invocation according to the target address information.

The resource description information of the target resource described in this specification is information for describing a feature of the target resource, and the target address information of the target resource may be uniquely determined in the recorded address information of the invokable resource by using the resource description information. For example, the resource description information of the target resource may include at least one of the following: a resource identifier of the target resource, and a resource name, such as a file name or a Software Development Kit (SDK) name; a version number, v1.0, v2.1, or the like; a creation time, an index of a storage location, and the like. In addition, the target address information may be specified by the first user and included in the resource invocation request, or may be further determined by the operating system in response to the resource invocation request. Details are not described again. It may be understood that, resource invocation is performed according to the target address information, that is, a corresponding target resource is invoked according to the target address information, that is, the target resource pointed to by the target access address represented by the target address information is invoked.

In this solution, the operating system of the computer creates the corresponding user sandbox for each user that logs in to the computer, and the user sandbox corresponding to any user records the address information of the invokable resource of the user, to achieve an isolation of each resource (that is, the invokable resource) that the user can invoke, by using the user sandbox. Based on this, the operating system may determine, in response to the resource invocation request initiated by the first user (any user in the plurality of users that concurrently log in to the computer) for the target resource, the first user sandbox corresponding to the first user. Then, the target address information of the target resource is queried in the address information of the first invokable resource recorded in the first user sandbox according to the resource description information of the target resource. The target address is an invocation address of the target resource required by the first user, so that resource invocation may be performed on the target resource according to the address.

It may be understood that the address information of the invokable resource of any user is recorded in the user sandbox corresponding to the user. Therefore, after the target address information is found in the first user sandbox, the target resource invoked according to the address inevitably belongs to the invokable resource of the first user. In addition, the first user can invoke the invokable resource that is of the first user and that is pointed to by the address information recorded in the first user sandbox, but cannot invoke an invokable resource that is of another user and that is pointed to by address information recorded in another user sandbox. It can be learned that, in this solution, resources (such as personal data and personal applications) that can be respectively invoked by different users are isolated by using different user sandboxes, so that a personal resource of any user is only visible to the user, a potential security risk caused by that personal resources of different users are visible to each other is avoided, and security of resources is improved.

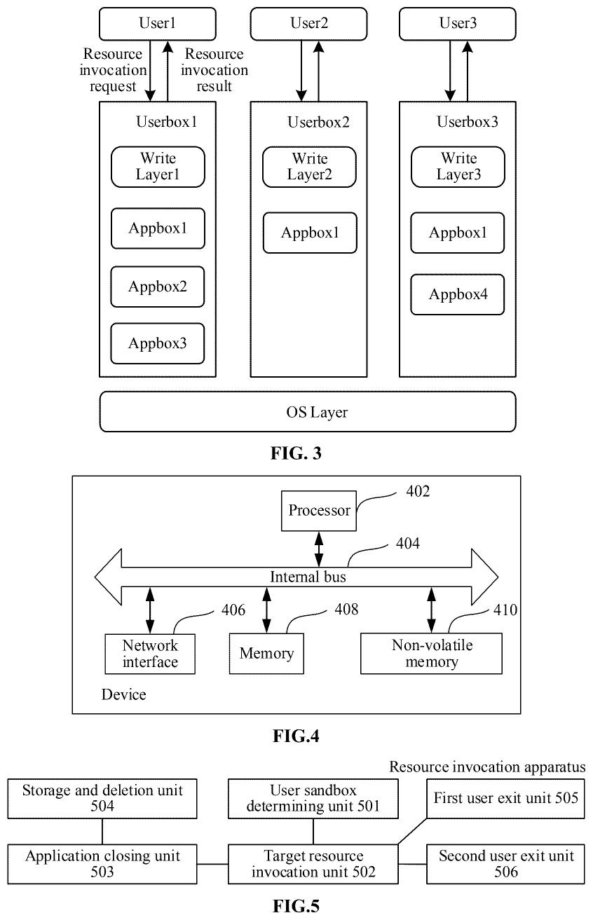

In an embodiment, the operating system may create, for each user, a corresponding user storage space in a user sandbox of the user. The user storage space of any user is configured for storing personal data (such as personal account information of the user or a historical record generated by using an application in the user sandbox) of the user. The user storage space in any user sandbox may be a local storage space of the computer, or may be another storage space that can be accessed by the computer, such as a database or a VHD that is added to the user sandbox after being mounted to the operating system of the computer. As shown in FIG. 3, three users, that is, a User1, a User2, and a User3, log in to a computer. Any user has a corresponding user sandbox, that is, the Userl corresponds to a Userbox1, the User2 corresponds to a Userbox2, and the User3 corresponds to a Userbox3. Each user sandbox includes a corresponding user storage space, that is, the Userbox includes a Write Layer1, the Userbox2 includes a Write Layer2, and the Userbox3 includes a Write Layer3. The same or different applications may alternatively run in each user sandbox, and an operating system may create a corresponding application sandbox for each application running in each user sandbox, for example, create corresponding Appbox1, Appbox2, and Appbox3 for an APP1, an APP2, and an APP3 running in the Userbox1, create an Appbox1 for an APP1 running in the Userbox2, and respectively create corresponding Appboxl and Appbox4 for an APP1 and an APP4 running in the Userbox3. As described above, the same or different APPs may run in different user sandboxes: for example, the APP1 (corresponding to Appbox1 included in each of the Userbox1, the Userbox2, and the Userbox3) may run in the Userbox1, the Userbox2, and the Userbox3, the APP2 and the APP3 (corresponding to the Appbox2 and the Appbox3 included in the Userbox1) may run in the Userbox1, and the APP4 (corresponding to the Appbox4 running in the Userbox3) may run in the Userbox3.

In addition, an Operating Layer (OS) Layer is separately drawn, representing that each user can share all system resources provided by the operating system of the computer (for example, evenly divide memory resources, occupy a CPU resource according to a load status, and invoke an SDK of a respective required version according to a record of a resource information collection), and it cannot be understood that the system resources exist independent of a user sandbox. Actually, the system resources (such as an SDK1 and an SDK2) of corresponding versions on which APPs that are respectively run in various user sandboxes respectively depend belong to a part of the OS Layer.

It may be understood that the user storage space of any user is equivalent to an invokable resource of the user. Therefore, a process in which the operating system invokes the target resource according to the target address information may include a process of performing read/write on the user storage space. For example, the operating system may determine, in the user storage space of the first user, available storage space represented by the target address information, and write to-be-stored data specified by the resource invocation request into the available storage space. In this manner, a write operation on the user storage space may be implemented. The available storage space may be empty (i.e., no data is written), or may not be empty, but data currently stored at the location is logged out, and the to-be-stored data may be directly written to cover the data. Or, occupied storage space represented by the target address information may be determined in the user storage space of the first user, and current data in the occupied storage space is read. The current data that is read may be data that is indicated by the resource invocation request and that needs to be read. In this manner, a read operation on existing data in the user storage space may be implemented. Certainly, the resource invocation request may specify a plurality of pieces of data, and in response to the request, the operating system may perform the foregoing write operation on (all) the data, may alternatively perform the foregoing read operation on (all) the data, or may perform the foregoing read operation on part of the data and perform the foregoing write operation on another part of the data. Details are not described again.

As described above, the operating system of the computer may provide system resources, and these system resources may be shared by the users that log in to the computer. Using a first user as an example, a first user sandbox records address information of a first invokable resource, and the first invokable resource may include the system resources. That is, during login, the first user may invoke the system resource represented by the address information recorded in the first user sandbox. The operating system may provide various types of system resources, and the first user sandbox may record address information of all or part types of system resources.

As described above, at least one application may be deployed in the first user sandbox. Based on this, in a process of operating a first application running in the first user sandbox, the first user may generate and initiate the resource invocation request by using the application, to trigger the operating system to invoke the target resource required by the application. Therefore, in a case that the target address information is determined, the operating system may invoke, according to the target address information, the target resource on which the first application depends for the first application running in the first user sandbox. Continuing to the foregoing embodiment of FIG. 3, if the first user and the first user sandbox are respectively the Userl and the Userbox1, and if an SDK (that is, a target resource) needs to be invoked during running of the first application APP1, then the first application APP1 may initiate a resource invocation request to the operating system, so that the operating system invokes the SDK for the first application APP1 according to the target address information. In this manner, the operating system may invoke a corresponding target resource for an application running in each user sandbox, normal running of each application is ensured, an adverse impact on a running process of an application used by a user due to setting of a user sandbox is avoided, and a data isolation effect between different users while ensuring normal functions of the application is achieved.

In an embodiment, the first application may be any application deployed in the first user sandbox, and the operating system may create a corresponding first application sandbox for the first application in the first user sandbox. The first application sandbox may record address information of a system resource on which the first application depends, and the address information is configured for invoking the system resource on which the first application depends. For example, the first application sandbox may maintain a resource list of the first application. The resource list is configured to record a resource identifier (such as a resource name), address information, and the like of each resource (that is, a system resource and/or a non-system resource on which the first application depends) in a resource information collection of the first application. The operating system may query, according to the list, address information of any resource on which the first application depends. In this manner, the address information of each resource on which the first application depends may be recorded in the first application sandbox, so as to implement application-level isolation on these resources, and facilitate invoking the resource on which the first application depends.

In a case that a plurality of applications are deployed in the first user sandbox, resource information collections respectively corresponding to these applications are usually sequentially loaded to the operating system according to a fixed query sequence. The loaded resource information collections form a unidirectional data structure (such as a linked list), so that the operating system can only query any system resource of any application request in each resource information collection according to the foregoing query sequence. Because the loaded resource information collections usually record various resources in a form of resource names and address information, for a system resource that is of a certain resource name and a certain version and that is requested by any application request, the operating system usually uses a first resource whose name matches the resource name as a query result when querying according to the foregoing query sequence based on the resource name. However, an actual version of the resource may not be the certain version requested by the application, but is another version on which another application relies. That is, the query result is wrong, and then running of the application may be abnormal.

To solve a problem that a conflict may be caused by invoking different versions of the system resource by the plurality of applications, this specification provides a manner of further creating an application in a user sandbox. For example, the operating system may create different application sandboxes for various applications in the first user sandbox, that is, the plurality of applications is in one-to-one mapping relationship with the plurality of application sandboxes. In this case, each application sandbox records address information of system resources on which corresponding applications depend. A first invokable resource corresponding to the first user sandbox includes the system resources on which the plurality of applications respectively depend. The resource invocation request may be generated for the first application. For example, the operating system may generate the request in response to a startup instruction for the first application to invoke a corresponding target system resource and start the first application depending on the resource, or invoke, in response to the resource invocation request generated by the first application in a running state (that is, after startup is completed), a corresponding target system resource to perform a processing operation indicated by the application.

The resource description information of the target resource may include a resource name of the target system resource included in the resource invocation request. The target system resource may have a plurality of versions and different versions of the target system resource are respectively depended on by different applications. It may be understood that, the first application depends on a version of the target system resource, and at least one application that depends on another version of the target system resource may not be started, is being started, or is started (that is, is already in a running state). This is not limited in this specification. In this scenario, the operating system may query, in the following manner, the target address information of the target resource in the address information of the first invokable resource recorded in the first user sandbox: first determining a first application sandbox corresponding to the first application; and then querying, according to the resource name of the target system resource, the target address information of the target system resource corresponding to the resource name in the address information of the system resources recorded by the first application sandbox.

Similar to the foregoing user sandbox, an application sandbox corresponding to any application described in this specification is a program, a rule, or an environment configured for performing permission isolation/management on related data or a resource of the application, and may be configured for recording various resources on which the application depends (that is, resources that may be needed in a running process of the application). For example, resource names of these resources and address information of the resources in the computer may be correspondingly recorded, so that the operating system may query address information of any resource according to a resource name of the resource and invoke the resource.

In an embodiment, the first application sandbox corresponding to the first application may be pre-created, for example, a corresponding first application sandbox is created for the application when the first application is installed. Thereafter, the application may run in the application sandbox, data generated during running is correspondingly stored in the application sandbox, running and data isolation between the first application and other applications are fully implemented, and mutual interference between applications is avoided.

In another embodiment, the first application sandbox corresponding to the first application may alternatively be temporarily created by the operating system when the first application is started. For example, the operating system may create the first application sandbox for the first application in response to a startup instruction for the application. Then, an executable file of the first application is executed in memory space corresponding to the first application sandbox, to start the first application. The resource invocation request may be initiated by the first application after the first application is started. The startup instruction may be initiated by the first user. After receiving the startup instruction, the operating system may create the first application sandbox in the memory space of the computer, to increase a data processing speed related to the first application. The executable file is a main program configured for starting the first application, that is, the first application may be started in the memory space of the computer after the file is executed. A format of the executable file is not limited in this embodiment of this specification. For example, the executable file may be an .exe file, a .sys file, a .com file, a .dll file, or the like. Details are not described again.

The executable file of the first application belongs to a source file of the first application (the file is configured to record basic data such as a main program and code required for running the application). The source file may be pre-stored in a Network Attached Storage (NAS) device. In this case, the operating system may locally mount the executable file in a form of a VHD by using a virtual disk technology, and further add the executable file to the first application sandbox, so as to subsequently read the file in a remote access manner. In a case that the first application sandbox has been created, the operating system may record address information of the source file in the first application sandbox, and then read the executable file in a manner of remotely accessing the source file. Or, address information of the executable file may be first determined from the source file, and then the address information is recorded in the first application sandbox, so that the executable file is obtained from the location specified by the address information in the NAS in a remote access manner.

Certainly, because the source file of the first application may be generated based on a preset index, to ensure that the mounted source file can run normally, the operating system may perform redirection processing on the source file. If the source file is generated based on a “C:\Program Files” folder, in a case that the source file is mounted to any folder under any drive letter of the computer, the operating system may redirect address information of the folder to “C:\Program Files”, to ensure that all files in the source file can be normally accessed and run according to an index after the redirection.

In this manner, the operating system is allowed to locally mount the source file of the first application by using the virtual disk technology, and then add the source file to the first application sandbox. It may be understood that the source file may be generated by a publisher or a manager of the application in a pre-execution manner. In this case, the operating system can start and run the first application only by remotely accessing the source file, and does not need to “install” the first application locally on the computer, so that the first application can achieve a running effect of a cloud application, and deployment and maintenance workload of a user on the first application is greatly simplified. In addition, it helps save local storage space of the computer, so that the computer can run more applications concurrently, thereby improving an overall resource utilization rate of the computer.

In still another embodiment, a corresponding first application sandbox may alternatively be created for the application in a running process after the first application is started. For example, invocation for a resource, an operation on data, and the like may be involved in the running process of the first application, and the operating system may check various requests sent by the application, to identify a sensitive request therein. In a case that data that requests to be processed is sensitive data or a resource that requests to be invoked is a sensitive resource, the request may be determined as a sensitive request. The sensitive data may be a resource occupied or possibly occupied by another application, and the sensitive resource may be a resource invoked or possibly invoked by another application. In this case, the first application sandbox may be directly created for the first application, or a prompt instruction may be returned to the first application, so that the first application presents prompt information for the sensitive data and/or sensitive resource to a current user, and the user determines whether to create the first application sandbox for the first application. After the first application sandbox is created, related data generated during startup of the first application may be transferred to the sandbox, and then processing on the sensitive data or invocation of the sensitive resource is completed in the sandbox in response to the sensitive request. In this manner, a corresponding first application sandbox may be created for the first application when necessary, and is not created when not needed. Although a response time of a first sensitive request is prolonged, more resources can be saved for a computer by using a stricter application sandbox creation threshold (because creation and maintenance of the application sandbox similarly need to consume resources for calculation, storage, and the like). Especially in a case that a running process of the first application does not relate to sensitive data or a sensitive resource, a resource saving effect is more prominent.

Continuing to the embodiment shown in FIG. 3, if a first user and a first user sandbox are respectively the User1 and the Userbox1, it can be learned that three applications: the APP1, the APP2, and the APP3 run in the Userbox1, and the three applications respectively correspond to corresponding application sandboxes. For example, the APP1 runs in the Appbox1, the APP2 runs in the Appbox2, and the APP3 runs in the Appbox3.

In an embodiment, each application sandbox may respectively include a source file (a User Layer1, a User Layer2, and a User Layer3) and resource information collections (a Collection1, a Collection2, and a Collection3) of a corresponding application, which are not shown in FIG. 3. The source file may be locally mounted to an operating system by using a VHD technology and added to the corresponding application sandbox. The resource information collections record system resources on which corresponding applications depend. For example, the Collection1 records an SDK1(v1.0) (a resource name is “SDK1”, and a resource version is 1.0, similarly hereinafter), an SDK2(v1.0), and an SDK3(v1.0) on which the User1 depends. The Collection2 records an SDK1(v2.0) and an SDK2(v1.0) on which the User2 depends. The Collection3 records an SDK1(v3.0) and an SDK2(v3.0) on which the User3 depends. It is to be noted that, although a corresponding resource version is marked for each SDK in FIG. 2, version information of the SDK is not needed in a resource query process. To reduce a data volume of the resource information collection as much as possible and save available storage space of the application sandbox, the resource information may not record the resource version, but only record a resource name and address information of the resource.

Any one of the foregoing SDKs may be a system resource, or may be a non-system resource. For example, for each SDK on which the APP1 depends, the SDK1(v1.0) and the SDK2(v1.0) may be system resources, and the SDK3(v1.0) may be a non-system resource. For a certain version of a system resource which any application depends on, another version of the system resource may be depended on by another application. For the SDK1, the APP1 depends on a version 1.0 of the SDK1, the APP2 depends on a version 2.0 of the SDK1, and the APP3 depends on a version 3.0 of the SDK1. Certainly, any version of the system resource on which any application depends may be depended on by another application. For example, for the SDK2, both the APP1 and the APP2 depend on a version 1.0 of the SDK2. Moreover, a non-system resource on which any APP depends is usually provided by a publisher or an administrator of the APP (not provided by an operating system of a computer) and is exclusively occupied by the application. Therefore, this type of resource is depended on only by the APP. For example, the SDK3 has only a version 1.0 and is only depended on by the APP1. Actually, the non-system resource may not be included in the application sandbox, to reduce permission management load of the application sandbox as much as possible.

In this case, if the operating system receives a resource invocation request sent by any application, a user sandbox where the application is located may be determined according to a session identifier included in the request (in addition, a user corresponding to the user sandbox may be determined). For example, a sandbox identifier corresponding to an application identifier of the first application is determined according to a maintained first-class application mapping relationship between an application identifier of an application and a sandbox identifier of an application sandbox, and the application sandbox represented by the sandbox identifier is determined as the first application sandbox; or, in a case that different applications respectively run in different processes, a sandbox identifier corresponding to a first process identifier of a process where the first application is located is determined according to a maintained second-class application mapping relationship between a process identifier of a process where an application is located and a sandbox identifier of an application sandbox, and the application sandbox represented by the sandbox identifier is determined as the first application sandbox. Assuming that it is determined in the foregoing manner that the first user sandbox is the Userbox1, and the first application is the APP1 running in the Userbox1, in this case, target address information of a corresponding target resource may be queried from the Collectionl of the Appbox1 according to a resource name included in a resource invocation request. For example, in a case that the resource name is “SDK1”, address information of the SDK1(v1.0) recorded in the Collectionl may be determined as the target address information, and the SDK1(v1.0) is naturally a corresponding target resource.

In an embodiment, after the first application finishes running, the operating system may close the first application in response to a closing instruction for the first application. The closing instruction may be actively initiated by a first user, and in this case, the first application may be closed according to a volition of the user; or, the closing instruction may be automatically initiated by the operating system according to a preset plan, and in this case, the application may be closed according to the foregoing preset plan. For a specific closing process, refer to descriptions in the related technology. Details are not described herein again.

In this scenario, in addition to closing the first application, the operating system may further store a running result generated during running of the first application to a first storage device for reuse in a subsequent running process of the first application. For example, in a next startup process of the first application, the currently stored running result may be read from the NAS device, so that the user can view a previous running result after the first application is restarted, the user can carry out work in sequence, and troubles brought to the user by data loss is avoided. And/or, the first application sandbox may be deleted after the first application is closed, to recycle resources occupied by the first application, thereby improving a utilization rate of the resources.

In an embodiment, the operating system may present the first user sandbox in response to an exit instruction initiated by the first user, or store personal data generated during this login of the first user to a second storage device in response to the exit instruction for reuse in a subsequent login process of the first user, and the first user sandbox is deleted after storage is completed. Certainly, before deleting the first user sandbox, the first user may first be controlled to log out of a login status (or referred to as log out). In this manner, the first user sandbox created for the first user may be deleted in time after the first user exits, thereby recycling resources of the computer and improving a utilization rate of the resources. In addition, the exit instruction may be actively initiated by the first user, and in this case, the first user may exit according to a volition of the user; or, the exit instruction may be automatically initiated by the operating system according to a preset plan. In this case, the first user may be controlled to compulsorily exit according to the preset plan. The preset plan may be properly set according to an actual situation such as time, fees, or permissions. This is not limited in this specification.

Either of the first storage device and the second storage device may be local storage space of the computer, or may be another storage space that can be accessed by the computer, such as a database or a VHD that is added to the user sandbox after being mounted to the operating system of the computer, and may be set according to an actual requirement.

FIG. 4 is a schematic structural diagram of a device according to an exemplary embodiment. Referring to FIG. 4, from a perspective of hardware, the device includes a processor 402, an internal bus 404, a network interface 406, a memory 408, and a non-volatile memory 410. Certainly, the device may further include hardware required by other applications. One or more embodiments of this specification may be implemented based on software. For example, the processor 402 reads a corresponding computer program from a non-volatile memory 410 and runs the computer program in the memory 408. Certainly, in addition to a software implementation, one or more embodiments of this specification do not exclude other implementations, for example, logic devices or a software-hardware combination. That is, execution bodies of the following processing procedures are not limited to logic units and may alternatively be hardware or logic devices.

Referring to FIG. 5, in a software implementation, a resource invocation apparatus may include: a user sandbox determining unit 501, configured to determine, in response to a resource invocation request initiated by a first user for a target resource, a first user sandbox corresponding to the first user, where different users respectively correspond to different user sandboxes, and any one of the user sandboxes records address information of an invokable resource of a corresponding user; and a target resource invocation unit 502, configured to query, according to resource description information of the target resource, target address information of the target resource in the address information of a first invokable resource recorded in the first user sandbox, and perform resource invocation according to the target address information.

In an implementation, the user sandbox determining unit 501 is configured to: determine a sandbox identifier corresponding to a user identifier of the first user according to a maintained first-class user mapping relationship between a user identifier of a user and a sandbox identifier of a user sandbox, and determine the user sandbox represented by the sandbox identifier as the first user sandbox; or, determine a sandbox identifier corresponding to a first session identifier of a session to which the first user belongs according to a maintained second-class user mapping relationship between a session identifier of a session to which the user belongs and a sandbox identifier of a user sandbox, and determine the user sandbox represented by the sandbox identifier as the first user sandbox.

In an implementation, the invokable resource of each user includes user storage space for storing personal data of the corresponding user, and the target resource invocation unit 502 is configured to: determine, in user storage space of the first user, available storage space represented by the target address information, and write to-be-stored data specified by the resource invocation request into the available storage space; and/or, determine, in user storage space of the first user, occupied storage space represented by the target address information, and read current data in the occupied storage space.

In an implementation, the target resource invocation unit 502 is configured to: for a first application running in the first user sandbox, invoke, according to the target address information, the target resource on which the first application depends.

In an embodiment, a first application sandbox corresponding to the first application is deployed in the first user sandbox, the first application sandbox records address information of a system resource on which the first application depends, and the address information is configured for invoking the system resource on which the first application depends.

In an embodiment, the resource description information of the target resource includes a resource name of the target system resource included in the resource invocation request, the target system resource has a plurality of versions, and different versions of the target system resource are respectively depended on by different applications. The target resource invocation unit 502 is configured to: determine a first application sandbox corresponding to the first application; and query, according to the resource name of the target system resource, the target address information of the target system resource corresponding to the resource name in the address information of the system resource recorded by the first application sandbox.

In some implementations, the apparatus further includes: an application closing unit 503, configured to close the first application in response to a closing instruction for the first application; a storage and deletion unit 504, configured to: store a running result generated during running of the first application to a first storage device for reuse in a subsequent running process of the first application; and/or, delete the first application sandbox after the first application is closed.

In some implementations, the apparatus further includes: a first user exit unit 505, configured to delete the first user sandbox in response to an exit instruction initiated by the first user; and/or, a second user exit unit 506, configured to store, in response to the exit instruction initiated by the first user, personal data generated during this login of the first user to a second storage device for reuse in a subsequent login process of the first user, and delete the first user sandbox after storage is completed.

In an embodiment, the apparatus is applied to a virtual machine on which a cloud desktop instance is deployed, where the first user sandbox is created and maintained by an operating system of the virtual machine, and the resource invocation request is initiated to the operating system by using the cloud desktop instance.

In this solution, the operating system of the computer creates the corresponding user sandbox for each user that logs in to the computer, and the user sandbox corresponding to any user records the address information of the invokable resource of the user, to isolate each resource (that is, the invokable resource) that the user can invoke within the user sandbox. Based on this, the operating system may determine, in response to the resource invocation request initiated by the first user (any user in the plurality of users that concurrently log in to the computer) for the target resource, the first user sandbox corresponding to the first user. Then, the target address information of the target resource is queried in the address information of the first invokable resource recorded in the first user sandbox according to the resource description information of the target resource. The address is an invocation address of the target resource required by the first user, so that resource invocation may be performed on the target resource according to the address.

It may be understood that the address information of the invokable resource of any user is recorded in the user sandbox corresponding to the user. Therefore, after the target address information is found in the first user sandbox, the target resource invoked according to the address inevitably belongs to the invokable resource of the first user. In addition, the first user can invoke the invokable resource that is of the first user and that is pointed to by the address information recorded in the first user sandbox, but cannot invoke an invokable resource that is of another user and that is pointed to by address information recorded in another user sandbox. It can be learned that, in this solution, resources (such as personal data and personal applications) that can be respectively invoked by different users are isolated by using different user sandboxes, so that a personal resource of any user is only visible to the user, a potential security risk caused by that personal resources of different users are visible to each other is avoided, and security of resources is improved.

The system, the apparatus, the module or the unit described in the foregoing embodiments may be specifically implemented by a computer chip or an entity, or implemented by a product having specific functions. A typical implementation device is a computer. A specific form of the computer may be a personal computer, a laptop computer, a cellular phone, a camera phone, a smartphone, a personal digital assistant, a media player, a navigation device, an email transceiver device, a game console, a tablet computer, a wearable device or a combination of any of these devices.

In a typical configuration, the computer includes one or more Central Processing Units (CPUs), an input/output interface, a network interface, and a memory.

The memory may include a form such as a volatile memory, a Random-Access Memory (RAM) and/or a non-volatile memory such as a Read-Only Memory (ROM) or a flash RAM in a computer-readable medium. The memory is an example of the computer-readable medium.

The computer-readable medium includes a non-volatile medium, a volatile medium, a removable medium, and a non-removable medium, which may implement information storage by using any method or technology. The information may be a computer-readable instruction, a data structure, a program module, or other data. Examples of a storage medium of a computer include, but are not limited to, a Phase-Change Memory (PRAM), a Static Random-Access Memory (SRAM), a Dynamic Random-Access Memory (DRAM), a RAM of another type, a Random Only Memory (ROM), an Electrically Erasable Programmable Read-Only Memory (EEPROM), a Flash Memory or another memory technology, a Compact Disk Read-Only Memory (CD-ROM), a Digital Versatile Disk (DVD) or another optical storage device, a cassette tape, a magnetic disk storage, a quantum memory, a graphene-based storage medium or another magnetic storage device, or any other non-transmission medium, which may be configured to store information accessible by a computing device. According to definitions herein, the computer-readable medium does not include transitory computer-readable media, such as a modulated data signal and carrier.

It is further to be noted that, terms “include”, “contain” or any other variations thereof are intended to cover a non-exclusive inclusion, such that a process, method, commodity, or device including a series of elements not only includes those elements, but also includes those elements that are not explicitly listed, or includes elements inherent to such a process, method, commodity or device. Unless otherwise specified, an element limited by “include a/an . . . ” does not exclude other same elements existing in the process, method, commodity, or device that includes the element.

Specific embodiments of this specification are described above. Other embodiments fall within a scope of appended claims. In some embodiments, actions or steps recorded in the claims may be performed in sequences different from those in the embodiments and may still achieve an expected result. In addition, processes depicted in accompanying drawings are not necessarily performed in a specific sequence or successively to achieve an expected result. In some implementations, multitasking and parallel processing may be feasible or beneficial.

Terms used in one or more embodiments of this specification are merely used to describe specific embodiments but are not intended to limit one or more embodiments of this specification. “A”, “the”, and “this” in a singular form used in one or more embodiments of this specification and the appended claims are alternatively intended to include a plural form, unless other meanings are clearly indicated in context. It is further to be understood that term “and/or” used herein indicates and includes any or all possible combinations of one or more associated listed items.

It is to be understood that although terms “first”, “second”, “third” and the like may be used to describe various types of information in one or more embodiments of this specification, such information is not be limited to these terms. These terms are merely used to distinguish between information of the same type. For example, without departing from the scope of one or more embodiments of this specification, first information may alternatively be referred to as second information. Similarly, second information may alternatively be referred to as first information. Depending on the context, for example, the word “if” used herein may be interpreted as “while” or “when” or “determining . . . in response to”.

The foregoing descriptions are merely preferred embodiments of one or more embodiments of this specification, but are not intended to limit the one or more embodiments of this specification. Any modification, equivalent replacement, or improvement made within the spirit and principle of one or more embodiments of this specification fall within the protection scope of the one or more embodiments of this specification.

What is claimed:

1. A resource invocation method, comprising:
determining, in response to a resource invocation request initiated by a first user for a target resource, a first user sandbox corresponding to the first user, wherein different users respectively correspond to different user sandboxes, and any one of the user sandboxes records address information of an invokable resource of a corresponding user; and
querying, according to resource description information of the target resource, target address information of the target resource in the address information of a first invokable resource recorded in the first user sandbox, and performing resource invocation according to the target address information.

2. The method according to claim 1, wherein the determining the first user sandbox corresponding to the first user comprises:
determining a sandbox identifier corresponding to a user identifier of the first user according to a maintained first-class user mapping relationship between a user identifier of a user and a sandbox identifier of a user sandbox, and determining a user sandbox represented by the sandbox identifier as the first user sandbox; or,
determining a sandbox identifier corresponding to a first session identifier of a session to which the first user belongs according to a maintained second-class user mapping relationship between a session identifier of a session to which a user belongs and a sandbox identifier of a user sandbox, and determining a user sandbox represented by the sandbox identifier as the first user sandbox.

3. The method according to claim 1, wherein the invokable resource of each user comprises a user storage space for storing personal data of the corresponding user, and the performing resource invocation according to the target address information comprises:
determining, in the user storage space of the first user, an available storage space represented by the target address information, and writing to-be-stored data specified by the resource invocation request into the available storage space; and/or,
determining, in the user storage space of the first user, an occupied storage space represented by the target address information, and reading current data in the occupied storage space.

4. The method according to claim 1, wherein the performing resource invocation according to the target address information comprises:
for a first application running in the first user sandbox, invoking, according to the target address information, the target resource on which the first application depends.

5. The method according to claim 4, wherein a first application sandbox corresponding to the first application is deployed in the first user sandbox, the first application sandbox records address information of a system resource on which the first application depends, and the address information is configured for invoking the system resource on which the first application depends.

6. The method according to claim 5, wherein the resource description information of the target resource comprises a resource name of a target system resource comprised in the resource invocation request, the target system resource has a plurality of versions, and different versions of the target system resource are respectively depended on by different applications; and
the querying target address information of the target resource in the address information of the first invokable resource recorded in the first user sandbox comprises:
querying, according to the resource name of the target system resource, the target address information of the target system resource corresponding to the resource name in the address information of the system resource recorded by the first application sandbox.

7. The method according to claim 6, further comprising:
closing the first application in response to a closing instruction for the first application;
storing a running result generated during running of the first application to a first storage device for reuse in a subsequent running process of the first application; and/or, deleting the first application sandbox after the first application is closed.

8. The method according to claim 1, further comprising:
deleting the first user sandbox in response to an exit instruction initiated by the first user; and/or,
storing, in response to the exit instruction initiated by the first user, personal data generated during a current login of the first user to a second storage device for reuse in a subsequent login process of the first user, and deleting the first user sandbox after storage is completed.

9. The method according to claim 1, wherein the method is applied to a virtual machine on which a cloud desktop instance is deployed,
the first user sandbox is created and maintained by an operating system of the virtual machine, and the resource invocation request is initiated to the operating system through the cloud desktop instance.

10. (canceled)

11. An electronic device, comprising:
a processor; and
a memory configured to store instructions executable by the processor, wherein
the processor runs the executable instructions to perform operations comprising:
determining, in response to a resource invocation request initiated by a first user for a target resource, a first user sandbox corresponding to the first user, wherein different users respectively correspond to different user sandboxes, and any one of the user sandboxes records address information of an invokable resource of a corresponding user; and
querying, according to resource description information of the target resource, target address information of the target resource in the address information of a first invokable resource recorded in the first user sandbox, and performing resource invocation according to the target address information.

12. A non-transitory computer-readable storage medium, having computer instructions stored thereon, wherein the instructions implement steps of the method according to claim 1 when executed by a processor.

13. The electronic device according to claim 11, wherein the determining the first user sandbox corresponding to the first user comprises:
determining a sandbox identifier corresponding to a user identifier of the first user according to a maintained first-class user mapping relationship between a user identifier of a user and a sandbox identifier of a user sandbox, and determining a user sandbox represented by the sandbox identifier as the first user sandbox; or,
determining a sandbox identifier corresponding to a first session identifier of a session to which the first user belongs according to a maintained second-class user mapping relationship between a session identifier of a session to which a user belongs and a sandbox identifier of a user sandbox, and determining a user sandbox represented by the sandbox identifier as the first user sandbox.

14. The electronic device according to claim 11, wherein the invokable resource of each user comprises a user storage space for storing personal data of the corresponding user, and the performing resource invocation according to the target address information comprises:
determining, in the user storage space of the first user, an available storage space represented by the target address information, and writing to-be-stored data specified by the resource invocation request into the available storage space; and/or,
determining, in the user storage space of the first user, an occupied storage space represented by the target address information, and reading current data in the occupied storage space.

15. The electronic device according to claim 11, wherein the performing resource invocation according to the target address information comprises:
for a first application running in the first user sandbox, invoking, according to the target address information, the target resource on which the first application depends.

16. The electronic device according to claim 15, wherein a first application sandbox corresponding to the first application is deployed in the first user sandbox, the first application sandbox records address information of a system resource on which the first application depends, and the address information is configured for invoking the system resource on which the first application depends.

17. The electronic device according to claim 16, wherein the resource description information of the target resource comprises a resource name of a target system resource comprised in the resource invocation request, the target system resource has a plurality of versions, and different versions of the target system resource are respectively depended on by different applications; and the querying target address information of the target resource in the address information of the first invokable resource recorded in the first user sandbox comprises:
querying, according to the resource name of the target system resource, the target address information of the target system resource corresponding to the resource name in the address information of the system resource recorded by the first application sandbox.

18. The electronic device according to claim 17, wherein the operations further comprise:
closing the first application in response to a closing instruction for the first application;
storing a running result generated during running of the first application to a first storage device for reuse in a subsequent running process of the first application; and/or, deleting the first application sandbox after the first application is closed.

19. The electronic device according to claim 11, wherein the operations further comprise:
deleting the first user sandbox in response to an exit instruction initiated by the first user; and/or,
storing, in response to the exit instruction initiated by the first user, personal data generated during a current login of the first user to a second storage device for reuse in a subsequent login process of the first user, and deleting the first user sandbox after storage is completed.

20. The electronic device according to claim 11, wherein a virtual machine is deployed in the electronic device, and a cloud desktop instance is deployed on the virtual machine, and
the first user sandbox is created and maintained by an operating system of the virtual machine, and the resource invocation request is initiated to the operating system through the cloud desktop instance.
